(19) United States
(12) Patent Application Publication
(10) Pub. No.: US 2006/0219421 A1
(43) Pub. Date: Oct. 5, 2006

(54) Cable or the like protection and guide device

(75) Inventor: Seiji Kitagawa, Osaka (JP)

Correspondence Address: Woodling, Krost, & Rust (Kenneth L. Mitchell), 9213 Chillicothe Road, Kirtland, OH, 44094, US

(73) Assignee: TSUBAKIMOTO CHAIN CO.

(21) Appl. No.: 11/357,483

(22) Filed: Feb. 18, 2006

(30) Foreign Application Priority Data
Mar. 29, 2005 (JP) 2005-095226

(51) Int. Cl. H02G 15/22

(52) U.S. Cl. 174/19

(57) ABSTRACT

The present invention provides a cable protection and guide device adapted for easy, sure storage and arrangement of cables in a cable storage space. The cable protection and guide device 100 is detachably provided with a partition shelf board member 120 for dividing a cable storage space R for storing, arranging, guiding and protecting cables C into a bending inner circumferential side and a bending outer circumferential side, and a pair of partition wall board members 130 for laterally dividing the space. The partition shelf board member 120 includes a pair of right and left engagement adaptor parts 121, 121 to be engaged with a pair of right and left partition wall board members 130, 130, respectively, and each of the partition wall board members 130 includes a pair of positioning ratchet teeth 131, 131 cut in slit opposed faces 131a, 131a.

This patent application claims priority of Japanese Patent Application 2005-095226 filed Mar. 29, 2005.

### TECHNICAL FIELD

The present invention relates to a cable or the like protection and guide device, more specifically, a cable or the like protection and guide device suitable for safely and surely guiding and protecting cables such as cables or hoses supplying electric power or energy of compressed air to a movable member of industrial machinery, as well as storing the cables, even during movement of the movable part.

### BACKGROUND ART

Conventionally, a cable or the like protection and guide device adapted to divide cables in multiple stages within a cable storage space is known.

Such a conventional cable or the like protection and guide device 500 is formed, as shown in FIGS. 7 and 8, by connecting a number of link bodies to be bendable in the longitudinal direction, each of the link bodies comprising a pair of link plates 511, 511 arranged with a space on both sides of cables C; a bending inner circumferential-side connecting plate 512 and a bending outer circumferential-side connecting plate 513 laterally laid between the link plates 511, 511 on the bending inner circumferential side and on the bending outer circumferential side, respectively; vertical partition plates 530 supported oppositely to the link plates 511, 511 with the bending inner circumferential-side connecting plate 512 and the bending outer circumferential-side connecting plate 513; and a lateral partition plate 520 incorporated with the vertical partition plates 530 through engagement holes 531 thereof.

A cable storage space R is divided by the lateral partition plate 520 incorporated with the vertical partition plates 530 into the bending outer circumferential side and the bending inner circumferential side, whereby two divided sections are formed to store and arrange the cables C in the divided sections as, for example, refer to Patent Document 1, Japanese Patent Application Laid-Open No. 2004-324851.

Problems to be Solved by the Invention

However, since the lateral partition plate 520 divides the cable storage space R based on the arrangement interval of the engagement holes 531 provided in the vertical partition plate 530 according to the opening positions of the engagement holes 531 provided in the vertical partition plates 530, the conventional cable or the like protection and guide device 500 cannot be adapted to various storage forms of the cables C conformed to the cable diameter sizes, the dividing numbers or the like in the cable storage space R, and thus has a problem in storage form that stable protective guide function cannot be exhibited because the cables C are laid in a constrained storage state or in an easy-to-sway storage state in the divided sections.

Further, since the lateral partition plate 520 is incorporated with the vertical partition plates 530 through the engagement holes 531 thereof, a sufficient space for piercing through the lateral partition plate 520 cannot be ensured between the pair of link plates 511, 511 in case that the lateral partition plate 520 is incorporated after incorporating the vertical partition plate 530 into the bending inner circumferential-side connecting plate 512, and the lateral partition plate 520 must be preliminarily inserted through the vertical partition plates 530 and incorporated therewith in an integrated manner before installed in the bending inner circumferential-side connecting plate 512. Namely, this device had a problem in incorporating procedure that the lateral partition plate 520 cannot be after-fitted.

Further, since the lateral partition plate 520 is installed on the bending inner circumferential-side connecting plate 512 in a state integrally incorporated with the vertical partition plates 530, this device also has a troublesome problem in cable handling that the cables C cannot be stored and arranged in the bending inner circumferential-side divided section without insertion of the cables C and, particularly, a situation that the cables C cannot be inserted into the bending inner circumferential-side divided section can arise if connectors are connected to the ends of the cables.

The present has been made to solve the above-mentioned problems, and the present invention provides a cable or the like protection and guide device adapted so as to be capable of easily and surely storing and arranging cables in a cable storage space, and sufficiently exhibit a stable cable protective guide function adaptively to various storage forms of cables.

Means for Solving the Problems

The present invention involves a cable or the like protection and guide device having a cable storage space for storing, arranging, guiding and protecting cables, formed by connecting a number of link frame bodies with rectangular frame cross-sectional shape, each of the link frame bodies being formed by laterally laying a bending inner circumferential-side connecting plate and a bending outer circumferential-side connecting plate between a pair of right and left link plates, respectively, so as to be mutually bendable through connecting pins and connecting pin holes provided in the link plates, and being detachably provided with a partition shelf board member for dividing the cables in the cable storage space into the bending inner circumferential side and to the bending outer circumferential side and a pair of right and left partition wall board members for laterally dividing the cables, in which the partition shelf board member includes a pair of right and left engagement adaptor parts to be engaged with the pair of right and left partition wall board members, and each partition wall board member includes a pair of positioning ratchet teeth cut in slit opposed surfaces to be engaged with each engagement adaptor part of the partition shelf board member in a predetermined shelf-catching partition position.

The present invention involves, in addition, that the pair of positioning ratchet teeth is formed oppositely to each other so as to nip the partition shelf board member in a state where it is arranged in parallel to the bending inner circumferential-side connecting plate or the bending outer circumferential-side connecting plate.

The present invention involves, in addition, that the partition wall board member includes a shelf board attachment/detachment part cut open on the bending outer circumferential side or the bending inner circumferential side of the slit opposed faces.

The present invention involves, in addition, that the shelf board attachment/detachment part of the partition wall board member is formed to be engageable with the bending outer circumferential-side connecting plate or the bending inner circumferential-side connecting plate.

The present invention involves, in addition, that the partition shelf board member includes a shelf board main body part detachably combined with the pair of right and left engagement adaptor parts so that the sectional area laterally divided by the pair of partition wall board members is changeable.

Effects of the Invention

The cable or the like protection and guide device of the present invention can guide and protect cables stored and arranged in the cable storage space to be freely bendable and also provide specific effects as described below, since a number of link frame bodies with rectangular frame cross-sectional shape, each of which is formed by laterally laying a bending inner circumferential-side connecting plate and a bending outer circumferential-side connecting plate between a pair of right and left link plates respectively, are connected to be freely bendable through connecting pins and connecting pin holes provided in the link plates, and a partition shelf board member for dividing cables in the cable storage space into the bending inner circumferential side and the bending outer circumferential side and partition wall board members for laterally dividing the cables are detachably provided.

Namely, according to the invention, since the partition shelf board member includes a pair of right and left engagement adaptor parts to be engaged with the pair of right and left partition wall board members respectively, and each partition wall board member includes a pair of positioning ratchet teeth cut in slit opposed faces to be engaged with each engagement adaptor part of the partition shelf board member in a predetermined shelf-catching partition position, the engagement adaptor part of the partition shelf board member can be surely nipped by the pair of positioning ratchet teeth in an optional shelf-catching partition position within the slit opposed faces. Therefore, the shelf-catching partition position of the partition shelf board member can be minutely set, or shelf-catching intervals can be set adaptively to various storage forms based on the diameter size, the dividing number or the like of the cables in the cable storage space, and a stable protective guiding function can be sufficiently exhibited to the cables in the respective divided sections.

According to the invention, since the pair of positioning ratchet teeth is formed oppositely to each other so as to nip the partition shelf board member in a state where it is arranged in parallel to the bending inner circumferential-side connecting plate or the bending outer circumferential-side connecting plate, in addition to the effect of the invention, the partition shelf board member is inserted to between the slit opposed faces with tilting around the board longitudinal axis, at the time of installing the partition shelf board member, and then rotated around the board longitudinal axis to be parallel to the bending inner circumferential-side connecting plate in a predetermined shelf-catching partition position, whereby the partition shelf board member can be surely nipped between the pair of positioning ratchet teeth. Therefore, the partition shelf board member can be easily set in an optional shelf-catching partition position without using a special tool for installation thereof.

According to the invention, since the partition wall board member includes a shelf board attachment/detachment part cut open at the bending outer circumferential side or the bending inner circumferential side of the slit opposed faces, installation of the partition shelf board member to the partitioning wall plate members installed to the bending inner circumferential-side connecting plate or the bending outer circumferential-side connecting plate, or so-called after-fitting of the partition shelf board member can be performed. Therefore, the partition shelf board member can be installed after the cables are stored and arranged on the bending inner circumferential-side connecting plate side or on the bending outer circumferential-side connecting plate side, and work procedures such as customer-responding assembling procedures can be remarkably improved with a variety of operability in maintenance work involved by taking-out and re-storage/arrangement of cables.

According to the invention, since the shelf board attachment/detachment part of the partition wall board member is formed to be engageable with the bending outer circumferential-side connecting plate or the bending inner circumferential-side connecting plate, the partition wall board member is never dropped out of the bending outer circumferential-side connecting plate or the bending inner circumferential-side connecting plate even if it is slightly deformed, resulting from the slit opposed faces and the partition shelf board member is also never coming out of the partition wall board member, and cables can be surely stored and arranged in the cable storage space.

Further, according to the invention, since the partition shelf board member includes a shelf board main body part detachably combined with the pair of right and left engagement adaptor parts so that the section area laterally partitioned by the pair of partition wall board members is changeable, the partition shelf board member can be surely fixed while nipping the partition wall board member. Therefore, the dropping-out of the partition shelf board member from the partition wall board member can be perfectly arrested. Further, since the length of the partition shelf board member can be freely and easily adjusted, the storage and arrangement form in the cable storage space can be diversified.

### BRIEF DESCRIPTION OF THE DRAWINGS

FIG. 1 is a perspective view of a cable or the like protection and guide device that is an example of the present invention;

FIG. 2 is a block diagram of a link frame body, a partition shelf board member and a partition wall board member of FIG. 1;

FIG. 3 is an enlarged perspective view of the partition wall board member of FIG. 2;

FIG. 4 is a block diagram of the partition shelf board member of FIG. 2;

FIG. 5 is an illustrative view showing the installing operation state of the partition shelf board member to the partition wall board member;

FIG. 6 is an illustrative view showing the installation completion state of the partition shelf board member to the partition wall board member;

FIG. 7 is a perspective view of a conventional cable or the like protection and guide device; and

FIG. 8 is a block diagram of a link frame body, a partition shelf board member, and a partition wall board member of FIG. 7.

A better understanding of the drawings will be had when reference is made to the Description of the Invention and Claims which follow herein below.

### DESCRIPTION OF THE INVENTION

The cable or the like protection and guide device of the present invention can have any concrete embodiment, if it can easily and surely store and arrange cables in the cable storage space and sufficiently exhibit stable protective guide function of cables adaptively to various storage forms of the cables by providing a pair of right and left engagement adaptor parts to be engaged with a pair of right and left partition wall board members on a partition shelf board, and providing a pair of positioning ratchet teeth cut in slit opposed faces to be engaged with each engagement adaptor part of the partition shelf board member in a predetermined shelf-catching partition position on each of the partition wall board members.

For example, the link frame body adapted in the cable or the like protection and guide device of the present invention can have a rectangular frame cross-sectional shape formed by laterally laying a bending inner circumferential-side connecting plate and a bending outer circumferential-side connecting plate between a pair of right and left link plates respectively. As a concrete example thereof, both the bending inner circumferential-side connecting plate and the bending outer circumferential-side connecting plate or only the bending outer circumferential-side connecting plate can be constituted in an openable/closeable arm-like shape so as to be engageable with the pair of right and left link plates. The link frame body can be formed by either integral molding or separate molding.

The shelf board attachment/detachment part of the partition wall board member adapted in the cable or the like protection and guide device of the present invention can be cut open at either the bending outer circumferential side or the bending inner circumferential side of the slit opposed faces, if the partition shelf board member can be installed to the partition wall board members installed to the bending inner circumferential-side connecting plate or the bending outer circumferential-side connecting plate, or after-fitting of the partition shelf board member can be performed.

Further, materials of the link frame body, the partition wall board member and the partition shelf board member adapted in the cable or the like protection and guide device of the present invention can be formed of any engineering plastic resins which can exhibit stable protective guiding function while storing cables in the cable storage space. For example, polyamide-6 resin, polyamide-12 resin, polyamide-46 resin, polyamide-66 resin, acrylic resin, polyacetal resin and the like, which are easy to mold, can be adapted, and a reinforced resin containing a high-strength material such as a glass fiber-reinforced polyamide-based resin is also adaptable.

### EXAMPLES

A preferred embodiment of the present invention will be described with reference to the accompanying drawings.

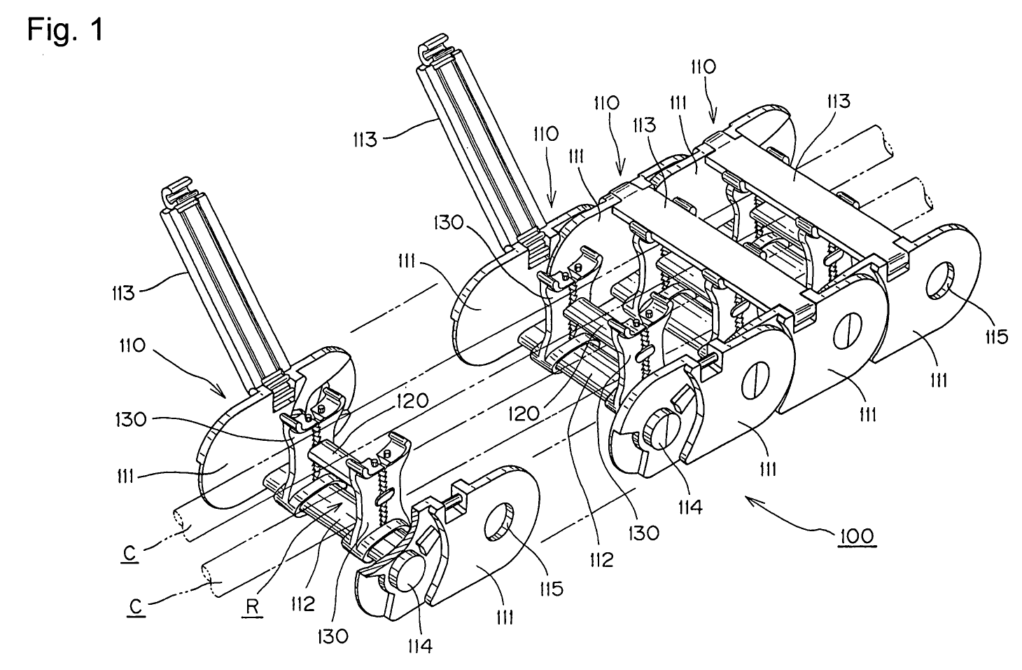

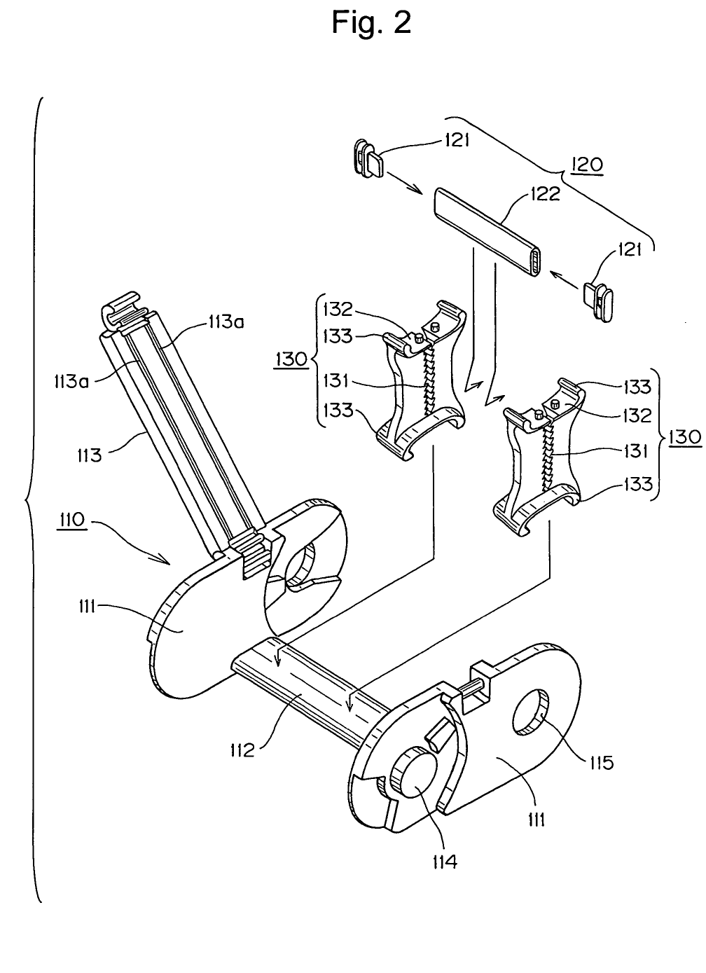

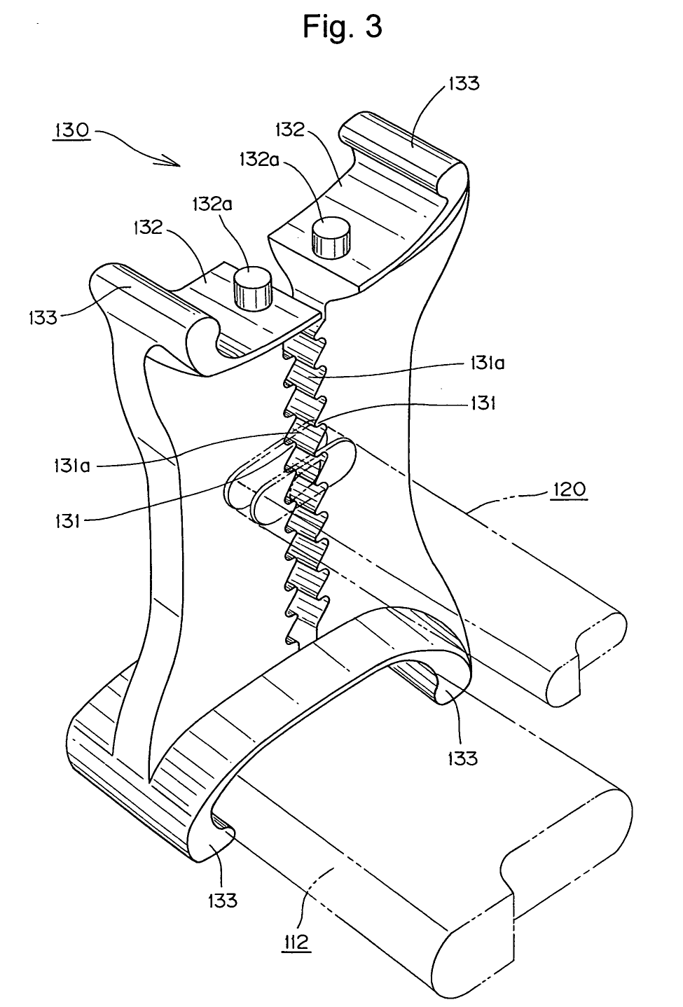

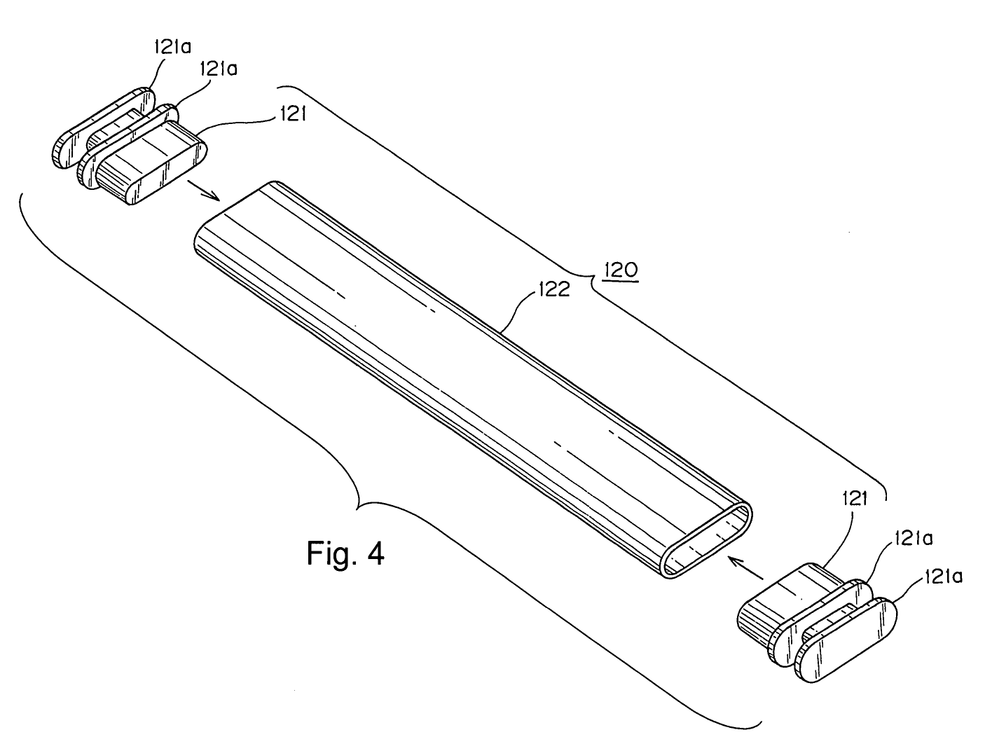

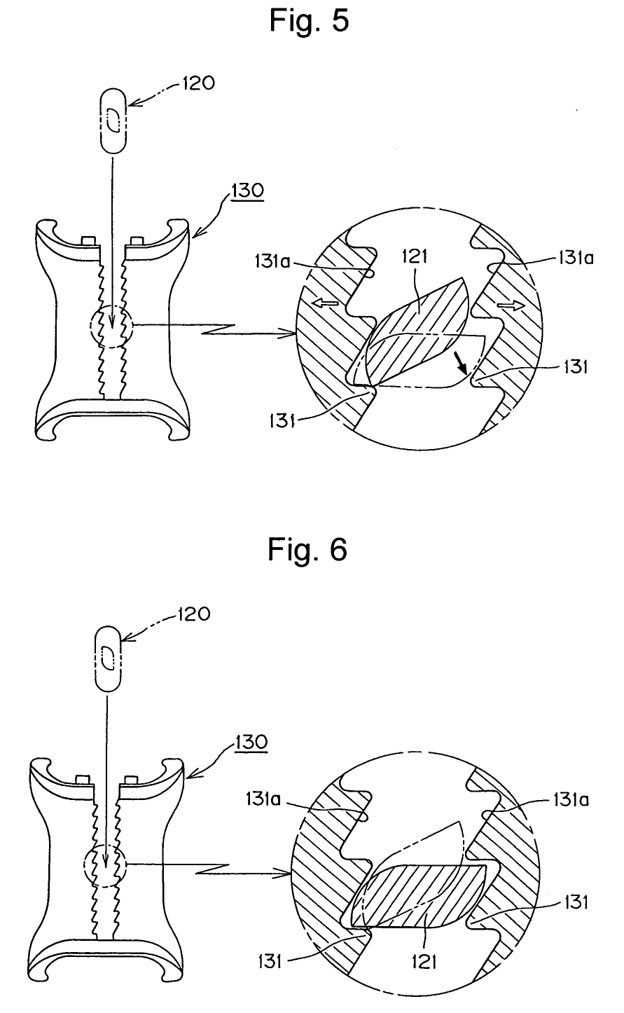

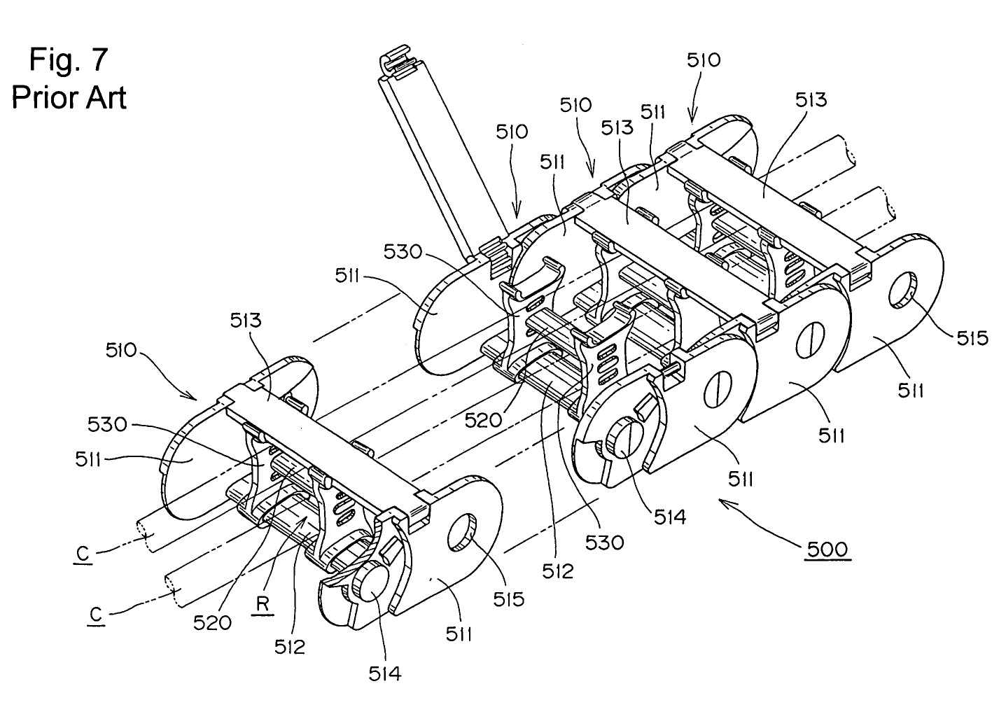

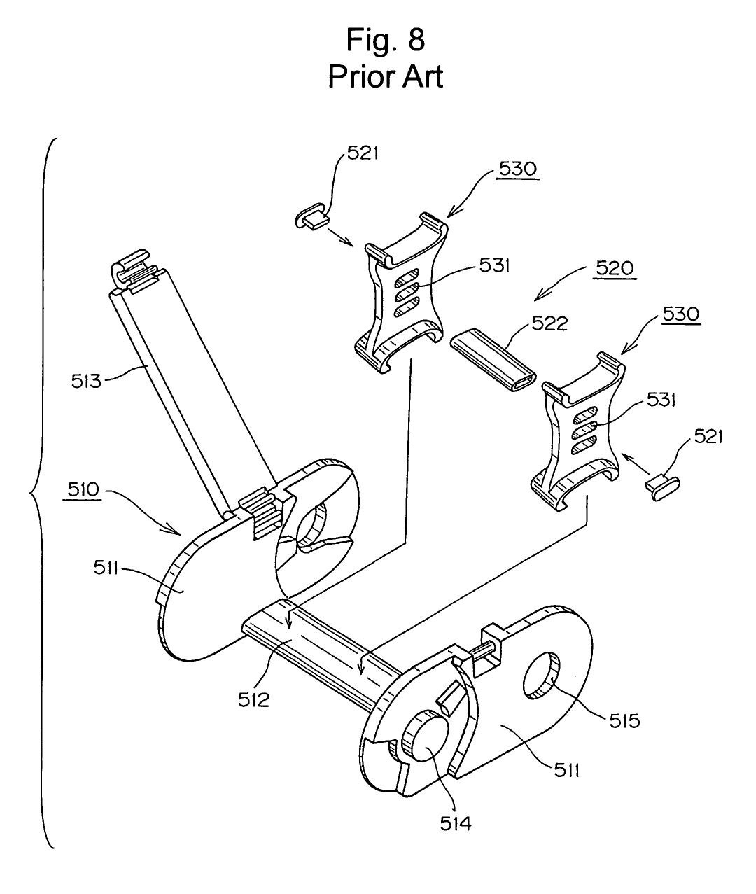

FIG. 1 is a perspective view of a cable or the like protection and guide device that is an example of the present invention, FIG. 2 is a block diagram of a link frame body, a partition shelf board member, and a partition wall board member of FIG. 1, FIG. 3 is an enlarged perspective view of the partition wall board member of FIG. 2, FIG. 4 is a block diagram of the partition shelf board member of FIG. 2, FIG. 5 is an illustrative view showing the installing operation state of the partition shelf board member to the partition wall board member, and FIG. 6 is an illustrative view showing the installation completion state of the partition shelf board member to the partition shelf wall board member.

A cable or the like protection and guide device 100 that is one example of the present invention shown in FIG. 1 is used to protectively guide cables C such as electric cables for transmitting electric signal or supplying power or hoses for supplying oil pressure or air pressure, which connect a movable part to a stationary part in a semiconductor chip mounter, a machine tool, a vehicle or the like. This device is adapted to be capable of presenting a linear state or a bent state according to the moving state between the movable part and the stationary part (not shown) by connecting a number of rectangular link frame bodies 110 lengthwise, so that the cables C can be protectively guided within a cable storage space R formed by continuing the link frame bodies 110 in a state where the cables C are inserted therethrough.

The link frame body 110 is molded of a glass fiber-reinforced polyamide-based resin which can exhibit an excellent strength characteristic, and formed by integrating a pair of right and left link plates 111, 111 arranged with a space with a bending inner circumferential-side connecting plate 112 laterally laid between the bending inner circumferential sides of the link plates 111, 111 and a bending outer circumferential-side connecting plate 113 laterally laid between the bending outer circumferential sides thereof in a rectangular shape.

Namely, the bending inner circumferential-side connecting plate 112 is integrated with the pair of right and left link plates 111, 111 by injection molding, while one end of the bending outer circumferential-side connecting plate 113 is rotatably connected to one of the link plates 111 in an arm-like shape, and the other end is openable and closable to be engageable with the other link plate 111.

Each link plate 111 has a so-called offset structure in which a step is formed in the plate thickness direction between the forward side and the backward side of the plate. The link plate 111 is further provided with a connecting pin 114 on the backward side of the plate and a connecting pin hole 115 substantially the same in diameter as the connecting pin 114 on the forward side of the plate.

Therefore, the link frame bodies 110 are mutually connected by mutually fitting the connecting pin 114 and the connecting pin hole 115 of the continuously disposed link plates 111, 111 and can be bent about the connecting pin 114.

In this example, further, a partition shelf board member 120 for dividing the cables C in the cable storage space R into the bending inner circumferential side and to the bending outer circumferential side and a pair of partition wall board member 130 for laterally dividing them are detachably installed to each pair of link plate 111 as shown in FIG. 2. Concretely, a pair of partition wall board members 130, 130 are detachably installed between the bending inner circumferential-side connecting plate 112 and the bending outer circumferential-side connecting plate 113, and the partition shelf board member 120 is installed to the partition wall board members 130, 130 in a horizontal state. The partition wall board members 130 can be installed in a desired position in the arrangement direction of the pair of right and left link plates 111, 111 (hereinafter referred simply to as “lateral arrangement direction”).

Part structures of the partition shelf board member 120 and the partition wall board member 130 which are most characteristic in the cable or the like protection and guide device 100 of this example and installation structures thereof will be described based on FIGS. 2 to 6.

The partition wall board member 130 used in the cable or the like protection and guide device 100 of this example includes, as shown in FIGS. 2 and 3, a pair of positioning ratchet teeth 131, 131, which are formed oppositely to each other so as to nip the partition shelf board member 120 in a state where it is arranged in parallel to at least the bending inner circumferential-side connecting plate 112.

The partition wall board member 130 includes a shelf board attachment/detachment part 132 cut open at the bending outer circumferential side of slit opposed faces 131a and 131a so that the partition shelf board member 120 can be installed to the partition wall board member 130 installed to the bending inner circumferential-side connecting plate 112, or after-fitting of the partition shelf board member 120 can be performed. Therefore, the partition shelf board member 120 can be installed after the cables C are stored and arranged on the bending inner circumferential-side connecting plate 112 side, and work procedures such as customer-responding assembling procedures can be remarkably improved with a variety of operability in maintenance work involved by taking-out and re-storage/arrangement of the cables C.

Further, the shelf board attachment/detachment part 132 includes a pair of front and rear engaging projections 132a to be engaged with engaging grooves 113a of the bending outer circumferential-side connecting plate 113, so that even if the partition wall board member 130 is slightly deformed, resulting from the slit opposed faces 131a and 131a, the cables C can be surely stored and arranged in the cable storage space R without causing dropping-out of the partition wall board member 130 from the bending outer circumferential-side connecting plate 113 or dropping-out of the partition shelf board member 120 from the partition wall board member 130.

Denoted at 133 in FIGS. 2 and 3 are engagement pawls for installing the partition wall board member 130 in a grasping state to the bending inner circumferential-side connecting plate 112 and the bending outer circumferential-side connecting plate 113.

The partition shelf board member 120 used in the cable or the like protection and guide device 100 of this example comprises, as shown in FIGS. 2 to 4, a pair of right and left engagement adaptor parts 121, 121 to be engaged with the pair of right and left partition wall board members 130, 130, respectively, and a shelf board main body part 112 to be detachably combined with the engagement adaptor parts 121, 121. Each engagement adaptor part 121 includes a pair of engagement flanges 121a, 121a for engaging the partition wall board member 130 while nipping both the sides thereof, so that the engagement adaptor parts 121, 121 of the partition shelf board member 120 are surely engaged with the partition wall board members 130 to perfectly arrest the dropping-out.

The shelf board main body part 122 is replaced so as to conform to a laterally partitioned section area determined by the arrangement space of the pair of partition wall board members 130, 130, whereby the length of the partition shelf board member 120 can be freely and easily adjusted to diversify the storage and arrangement form in the cable storage space R.

Further, the shelf board main body part 122 of the partition shelf board member 120 in this example can be cut in an optional length and easily adjusted in length because it is an aluminum extrusion. Therefore, it is not necessary to form many injection molding dies for the partition shelf board member 120 in conformation to each width of the laterally divided section area determined by the arrangement space of the pair of partition wall board members 130, 130, and the cost can be significantly reduced. As the shelf board main body part 122, a resin injection molded product can be used in place of the aluminum extrusion.

The engagement adaptor part 121 of this example is made of a resin molded product, but other metal molded products can be used also.

The installation procedure of the partition shelf board member 120 and the partition wall board member 130 will be described based on FIGS. 5 and 6.

When the partition shelf board member 120 is installed to the partition wall board member 130, as shown in FIG. 5, the partition shelf board member 120 is inserted to a predetermined shelf-catching partition position within the slit opposed faces 131a, 131a in a state tilted around the board longitudinal central axis while avoiding the contact with the pair of positioning ratchet teeth 131, 131 as much as possible. The partition shelf board member 120 is then rotated around the board longitudinal central axis in the shelf-catching partition position from an inclined attitude shown by the full line to a horizontal attitude parallel to the bending inner circumferential-side connecting plate 112 shown by the dotted line to push out the pair of positioning ratchet teeth 131, 131, and laid in a state parallel to the bending inner circumferential-side connecting plate 112.

As is apparent from FIG. 6, the partition shelf board member 120 is rotated around the board longitudinal central axis from the inclined attitude shown by the dotted line to the horizontal attitude parallel to the bending inner circumferential-side connecting plate 112 shown by the full line, whereby the partition shelf board member 120 is surely nipped between the pair of positioning ratchet teeth 131, 131 and laid in an installation completion state to the partition wall board member 130.

It will be obvious without illustration to perform the reverse of the above-mentioned installation procedure in removing the partition shelf board member 120 from the predetermined shelf-catching partition position of the partition wall board member 130.

The thus-obtained cable or the like protection and guide device 100 of this example can easily and surely store and arrange the cables C in the cable storage space R and sufficiently exhibit stable protective guide function of the cables C adaptively to various shortage forms of the cables C, since the partition shelf board member 120 includes the pair of right and left engagement adaptor parts 121, 121 to be engaged with the pair of right and left partition wall board members 130, 130, and each partition wall board member 130 includes a pair of positioning ratchet teeth 131 and 131 cut in the slit opposed faces 131a, 131a to be engaged with each engagement adaptor part 121 of the partition shelf board member 120 in a predetermined shelf-catching partition position.

Since the pair of positioning ratchet teeth 131 and 131 are formed oppositely to each other so as to nip the partition shelf board member 120 in a state where it is arranged in parallel to the bending inner circumferential-side connecting plate 112, the partition shelf board member 120 is inserted between the slit opposed faces 131a and 131a in a state tilted around the board longitudinal central axis, at the time of installing the partition shelf board member 120, and rotated around the board longitudinal central axis in the predetermined shelf-catching partition position to be parallel to the bending inner circumferential-side connecting plate 112, whereby the partition shelf board member 120 is surely nipped by the pair of positioning ratchet teeth 131, 131. Therefore, the partition shelf board member 120 can be easily positioned and set in an optional shelf-catching partition position without using a special tool for installing it.

Since the partition wall board member 130 comprises the shelf board attachment/detachment part 132 cut open on the bending outer circumferential side of the slit opposed faces 131a and 131a, the partition shelf board member 120 can be installed after storing and arranging the cables C on the bending inner circumferential side connecting plate 112 side, and work procedures such as customer-responding assembling procedures can be remarkably improved with a variety of operability in maintenance work involved by taking-out and re-storage/arrangement of the cables C and produce a great effect.

### DESCRIPTION OF THE REFERENCE NUMERALS

100 Cable or the like protection and guide device
110 Link frame body
111 Link plate
112 Bending inner circumferential-side connecting plate
113 Bending outer circumferential-side connecting plate
113a Engaging grooves
114 Connecting pin
115 Connecting pin hole
120 Partition shelf board member
121 Engagement adaptor part
121a Engagement flanges
122 Shelf board main body part
130 Partition wall board members
131 Positioning ratchet teeth
131a Slit opposed faces
132 Shelf board attachment/detachment part
132a Engaging projections
133 Engagement pawls
500 Cable or the like protection and guide device
510 Link frame body
511 Link plates
512 Bending inner circumferential-side connecting plate
513 Bending outer circumferential-side connecting plate
514 Connecting pin
515 Connecting pin hole
520 Lateral partition plate
530 Vertical partition plate
531 Engagement holes
C Cables
R Cable storage space

The invention has been set forth by way of examples and those skilled in the art will readily recognize that changes and modifications may be made to the examples without departing from the spirit and scope of the appended claims.

1. A cable protection and guide device having a cable storage space for storing, arranging, guiding and protecting cables, formed by connecting a number of link frame bodies with rectangular frame cross-sectional shape, each link frame body being formed by laterally laying a bending inner circumferential-side connecting plate and a bending outer circumferential-side connecting plate between a pair of right and left link plates, respectively, so as to be mutually bendable through connecting pins and connecting pin holes provided in the link plates, and being detachably provided with a partition shelf board member for dividing the cables in the cable storage space into the bending inner circumferential side and the bending outer circumferential side, and a partition wall board member for laterally dividing the cables,
said partition shelf board member including a pair of right and left engagement adaptor parts to be engaged with a pair of right and left said partition wall board members; and
said partition wall board member including a pair of positioning ratchet teeth cut in slit opposed surfaces to be engaged with each engagement adaptor part of the partition shelf board member in a predetermined shelf-catching partition position.

2. The cable protection and guide device according to claim 1, wherein said pair of positioning ratchet teeth is formed oppositely to each other so as to nip said partition shelf board member in a state where it is arranged in parallel to the bending inner circumferential-side connecting plate or the bending outer circumferential-side connecting plate.

3. The cable protection and guide device according to claim 1, wherein said partition wall board member includes a shelf board attachment/detachment part cut open on the bending outer circumferential side or the bending inner circumferential side of the slit opposed faces.

4. The cable protection and guide device according to claim 2, wherein said partition wall board member includes a shelf board attachment/detachment part cut open on the bending outer circumferential side or the bending inner circumferential side of the slit opposed faces.

5. The cable protection and guide device according to claim 3, wherein the shelf attachment/detachment part of said partition wall board member is formed to be engageable with said bending outer circumferential-side connecting plate or said bending inner circumferential-side connecting plate.

6. The cable protection and guide device according to claim 4, wherein the shelf attachment/detachment part of said partition wall board member is formed to be engageable with said bending outer circumferential-side connecting plate or said bending inner circumferential-side connecting plate.

7. The cable protection and guide device according to claim 1, wherein said partition shelf board member includes a shelf board main body part detachably combined with said pair of right and left engagement adaptor parts so that the section area laterally divided by said pair of partition wall board members is changeable.

8. The cable protection and guide device according to claim 2, wherein said partition shelf board member includes a shelf board main body part detachably combined with said pair of right and left engagement adaptor parts so that the section area laterally divided by said pair of partition wall board members is changeable.

9. The cable protection and guide device according to claim 3, wherein said partition shelf board member includes a shelf board main body part detachably combined with said pair of right and left engagement adaptor parts so that the section area laterally divided by said pair of partition wall board members is changeable.

10. The cable protection and guide device according to claim 4, wherein said partition shelf board member includes a shelf board main body part detachably combined with said pair of right and left engagement adaptor parts so that the section area laterally divided by said pair of partition wall board members is changeable.

11. The cable protection and guide device according to claim 5, wherein said partition shelf board member includes a shelf board main body part detachably combined with said pair of right and left engagement adaptor parts so that the section area laterally divided by said pair of partition wall board members is changeable.

12. The cable protection and guide device according to claim 6, wherein said partition shelf board member includes a shelf board main body part detachably combined with said pair of right and left engagement adaptor parts so that the section area laterally divided by said pair of partition wall board members is changeable.
